(19) United States
(12) Patent Application Publication
(10) Pub. No.: US 2008/0265838 A1
(43) Pub. Date: Oct. 30, 2008

(54) Battery charging using a USB-ID pin of a USB interface

(76) Inventors: Saurabh Garg, Singapore (SG); Amol Subhash Pandit, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/789,175

(22) Filed: Apr. 24, 2007

(51) Int. Cl. H02J 7/00; G06F 3/00

(52) U.S. Cl. 320/115; 320/153; 710/15

(57) ABSTRACT

A device includes a rechargeable battery and a USB interface including a USB_ID pin. A charging device is connected to the device via the USB interface. A battery charging circuit in the device receives a charge via the USB_ID pin from the charging device, and the battery charging circuit charges the battery with the received charge.

### BACKGROUND

Portable devices, such as digital cameras, personal digital assistants (PDAs), cellular phones, laptops, etc., typically include a battery that provides power for the device when the device is not connected to a constant power source, such as an AC outlet.

It is necessary to provide a dedicated AC adapter or charger for charging the rechargeable battery for the portable device. It often happens that such an AC adapter or charger cannot be used to charge batteries for different types of portable devices. For example, the charger for a user's digital camera may have a different pin than the charger for the user's cellular phone. For that reason, when the user of a plurality of portable devices is traveling or otherwise away from the home or office, it may be necessary to carry a number of AC adapters or chargers, which is inconvenient.

Recently, the universal serial bus (USB) standard has suddenly permeated the marketplace, as an interface standard for connecting a personal computer (PC) to its peripherals. This USB standard has the advantage of enabling the use of one type of interface to connect different types of devices, making it possible to implement plug-and-play and hot-plug features.

A MINI-B USB interface, according to current specifications, includes data pins (D+ and D−), a USB identification pin (USB_ID) pin, a power bus pin (VBUS), and a ground pin (GND) pin. The MINI-B USB interface conforms to the USB specification promulgated by the USB Implementers Forum. In particular, the USB On-The-Go (OTG) specification describes the USB_ID pin in addition to the other four pins, i.e., D+, D−, VBUS and GND. Use of the VBUS and GND pins makes it possible to charge a device using the same interface that provides for data transfer. However, the current USB specification places limitations on the amount of current and voltage that may be supplied via VBUS, such as 500 mA and 5V. This impacts battery charging performance via a USB interface. Thus, if the device has an interface that is USB compliant, charging a battery in the device via the USB interface is typically slow.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates a system for charging a battery in a device through a USB_ID pin, according to an embodiment;

FIG. 2 illustrates a circuit in the device for charging a battery in the device using a USB_ID pin, according to an embodiment;

FIG. 3 illustrates a system for controlling boot up of a device, according to an embodiment;

FIG. 4 illustrates a circuit in the device for controlling boot up of the device and device type detection and recognition using a USB_ID pin, according to an embodiment;

FIG. 5 illustrates circuits from FIGS. 1 and 3 in a device, according to an embodiment; and

FIG. 6 illustrates a method for controlling boot up of a device and controlling battery charging in the device, according to an embodiment.

### DETAILED DESCRIPTION

For simplicity and illustrative purposes, the principles of the embodiments are described. However, one of ordinary skill in the art would readily recognize that the same principles are equally applicable to, and can be implemented using variations of the described embodiments.

According to an embodiment, a battery charging system is operable to charge a battery of a device through a USB_ID pin of a USB interface, also referred to as a USB port. The device may include a portable device or any device with a rechargeable battery. The battery charging system includes a charging device connected to the device via a USB interface. The charging device, for example, is a dock, AC adapter, or other device operable to provide a charge, such as a constant current or voltage, for recharging the battery in the device. The charging device supplies the charge to the device via the USB_ID pin in the USB interface in the device. The device includes a circuit for receiving the charge from the charging device and using the received charge to recharge the battery in the device.

The battery charging system provides a low cost solution for charging a battery in a device using a standard USB interface. Also, fast, safe and reliable in-device battery charging is provided that can be implemented on any device, including portable devices, having a USB port with a USB_ID pin. Charging via the USB_ID pin in a USB interface is faster than charging via the VBUS pin, because a charge with a higher current and/or voltage may be provided via the USB_ID pin.

According to another embodiment, a system is provided for controlling boot up of a device from a secondary device using a USB_ID pin of a USB interface. Conventionally, a PC may be connected to a device, such as a PDA, cellular phone, digital camera, etc., and control boot up of the device. For example, the device is connected to the PC via a USB port and USB cable. The device then uses current provided by the PC on the VBUS line of the USB cable to boot up itself. However, if a secondary device that is not a PC is connected to the device, the device does not recognize the secondary device and does not boot up even if current is being provided from the secondary device via the VBUS line in the USB cable. According to an embodiment, a secondary device is connected to the device via a USB interface including a USB_ID pin. The secondary device provides an identification signal via the USB_ID pin in the device. If the device recognizes the secondary device from its identification signal, the device may be booted up by the secondary device. The system provides automatic boot control of the device when the attached secondary device is recognized.

The embodiments described above may be used together in a single device to provide multifunction use of the USB_ID pin. For example, the USB_ID pin may be used for charging a battery in the device and/or may be used to detect and recognize a secondary device connected to the device. Furthermore, this multifunction use includes multiple uses for an existing pin provided in many devices. Thus, interfaces for many existing devices may not need to be adapted to use the embodiments described herein.

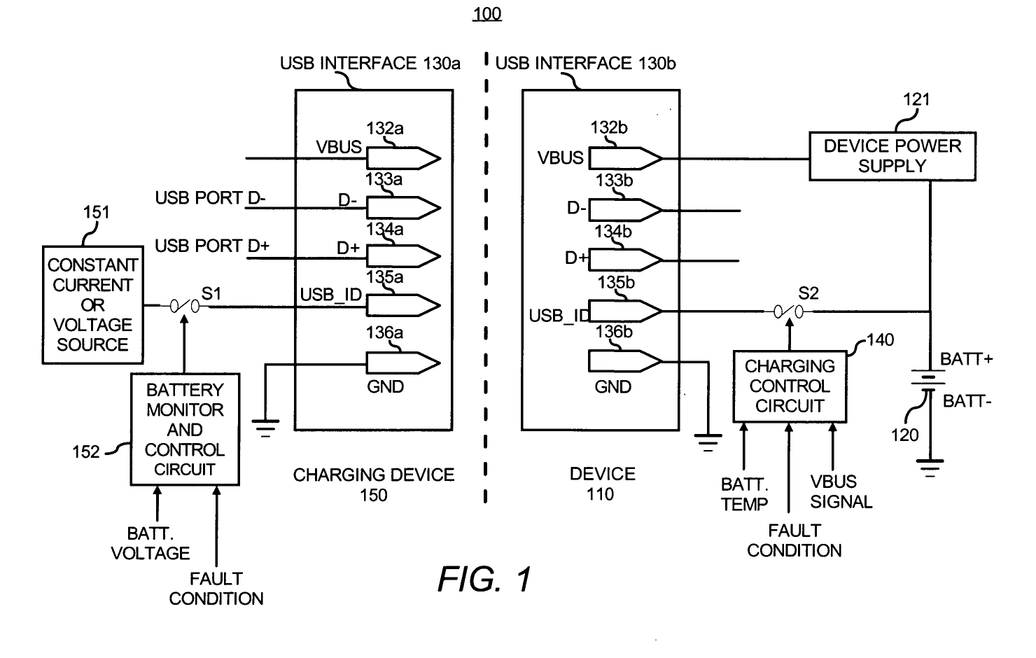

FIG. 1 illustrates a battery charging system 100, according to an embodiment. The system includes a device 110 with a rechargeable battery 120. A charging device 150 is connected to the device 110 via a USB interface 130a and 130b. In particular, the charging device 150 includes a USB interface 130a, and the device 110 includes a USB interface 130b. For example, the USB interface 130a is a USB plug and the USB interface 130b is a USB receptacle or vice versa. The USB interfaces 130a and 130b may be directly connected. For example, if the charging device 150 is a dock and the device 110 is a digital camera, the interfaces 130a and 130b may be connected if the camera is correctly placed on the dock. The dock may be a standalone dock or a dock in a device, such as a printer with a dock. In another example, the interfaces 130a and 130b are connected via a USB cable including lines corresponding to the interfaces, such as two data lines, a VBUS power line, a ground line, and a line that may be used for USB_ID.

Each of the USB interfaces 130a and 130b includes a set of pins 132a-136a and 132b-136b, including a VBUS pin 132a and 132b, two data pins (D− and D+) 133a, 133b, 134a and 134b, a USB_ID pin 135a and 135b and a ground pin (GND) 136a and 136b. The USB interfaces 130a and 130b including the pins 132a-136a and 132b-136b conform to the USB specification promulgated by the USB Implementers Forum. In particular, the USB On-The-Go (OTG) specification describes the USB_ID pin in addition to the other four pins, i.e., two for data, one for power (VBUS) and one for ground, shown in FIG. 1. The USB interfaces including the USB_ID pin are typically provided in Mini-B USB interfaces described in the current USB specification. The USB_ID pin may be any fifth pin in a USB compatible interface, other than the data pins, VBUS and GND pins. Typically, the USB_ID pin is used to identify host or master devices and slave devices for USB OTG compatible devices. However, many devices having the USB_ID pin in a USB interface are not USB OTG compatible and typically do not use the USB_ID pin. The embodiments described herein may be used with those type of devices and also with devices that are USB OTG compatible.

The device 110 may include any device with a rechargeable battery and a USB interface including a USB_ID pin and a VBUS pin. For example, the device 110 may include a portable electronic device, such as a digital camera, cellular phone, PDA, media player, etc., or a non-portable electronic device with the rechargeable battery and the USB interface. The charging device 150 may include a device operable to supply current via the USB interface 130b for charging the battery 120 of the device 110. For example, the charging device 150 may include a dock or an AC adapter, or the charging device 150 may include a PC or an accessory, such as a printer.

According to an embodiment, the USB_ID pins 135a-b are used to provide current from the charging device 150 to the battery 120 in the device 110 for charging the battery 120. The USB_ID pin 135b is connected to a terminal of the battery 120. The charging device 150 includes a charging circuit 151. When the charging circuit 151 provides a charge via the USB_ID pins 135a-b, the charge may be used to charge the battery 120. The charging circuit 151 supplies power for charging the battery 120 in the device. For example, the charging circuit 151 may supply a constant current or constant voltage via the USB_ID pins 135a-b for charging the battery. Other conventional methods of supplying power for charging a battery may also be used. For example, to charge lithium-ion batteries, the charging circuit 151 may adapt both constant current and constant voltage or provide power in various stages of charging to charge the battery 120.

The device 110 includes a charging control circuit 140 controlling the charging of the battery 120 using the charge provided via the USB_ID pin 135b from the charging device 150. The charging control circuit 140 may include inputs such as one or more of the battery temperature of the battery 120, fault conditions of the battery 120 or the device 110, and a VBUS signal. The charging control circuit 140 may enable charging of the battery 120 based on one or more of the inputs. For example, if the battery temperature is below a threshold, no fault condition(s) are detected and/or a predetermined voltage or current is detected on the VBUS pin 132b, then the charging control circuit 140 allows the battery 120 to be charged using the charge provided via the USB_ID pin 135b from the charging device 150. One or a plurality of these conditions must be satisfied in one embodiment to enable charging, or in another embodiment, all these conditions must be satisfied to enable charging. The charging control circuit 140 may enable charging by closing a switch S2 which connects the USB_ID pin 135b with the battery terminal for the battery 120. If the charging control circuit 140 determines that the required conditions to be satisfied to enable charging of the battery 120 are not satisfied, the charging control circuit 140 controls the switch S2 to be open.

As described above, the examples of the conditions to be satisfied based on the inputs to the charging control circuit 140 include battery temperature of the battery 120, fault conditions of the battery 120, and a VBUS signal. Regarding the battery temperature input, a thermistor or other conventional device may be used to sense the battery temperature. If the battery temperature rises above a battery temperature threshold, associated with a safety limit, the switch S2 is opened by the charging control circuit 140. This terminates battery charging of the battery 120 and hence prevents any safety issues.

Regarding the VBUS signal input to the charging control circuit 140, when the charging device 150 is connected to the device 110, the charging device 110 generates a VBUS signal on the VBUS pin 132b. This may be a predetermined voltage or current, e.g., 5V and/or 500 mA. The VBUS signal may be an indication that a device connected to the device 110 is a charging device operable to charge the battery 120 via the USB_ID pin 135b and/or supply power to the device 110 via the VBUS line. If the VBUS signal is not detected, the charging control circuit 140 may not enable charging of the battery 120, for example, by opening the switch S2.

Regarding the fault condition input to the charging control circuit 140, the fault condition may include a battery fault condition. A fault condition may include a non-chargeable battery or a battery voltage outside an acceptable operating range. For example, a fault is detected if battery voltage falls below a lower fault threshold, e.g., 1V, or if the battery voltage is above an upper fault threshold, e.g., 3.8V.

The device power supply 121 is connected to the battery 120 and the VBUS line connected to the VBUS pin 132b. If the charging control circuit 140 closes the switch S2 to enable charging via the USB_ID pin 135b and power is supplied from the charging device 150 to the device 110 via the VBUS pin 132b, the charging control circuit 140 sends a signal to the device power supply 121 to disconnect the battery 120 from the device power supply 121. The device power supply 121 may include a switch that either connects input power for the device 110 to the VBUS line or the battery 120. Once the battery 120 is disconnected from the device power supply 121, the battery 120 may be charged without being simultaneously drained because it is not providing power for the device 110 when disconnected from the device power supply 121.

The charging device 150 may include a battery monitor and control circuit 152 monitoring the battery voltage of the battery 120 in the device 110 and detecting fault conditions of the battery 120. If the battery voltage reaches a threshold indicating the battery 120 is fully charged, the battery monitor and control circuit 152 terminates charging, for example, by opening a switch S1 connecting the charging circuit 151 to the USB_ID pin 135a and 135b. Also, if a fault condition of the battery is detected, battery monitor and control circuit 152 may also terminate charging. A fault condition may include a non-chargeable battery or a battery voltage outside an acceptable operating range. For example, a fault is detected if battery voltage falls below a lower fault threshold, e.g., 1V, or if the battery voltage is above an upper fault threshold, e.g., 3.8V. The 1V and 3.8V thresholds are for M batteries with a 1.2V nominal voltage. It will be apparent to one of ordinary skill in the art that different thresholds may be used for different types of batteries and other types of battery fault conditions may also be detected. The battery monitor and control circuit 152 may determining whether the battery 120 is fully charged or whether a fault condition occurred from the voltage on the USB_ID line connected via the USB_ID pins 135a and 135b or by testing the battery via the USB_ID line.

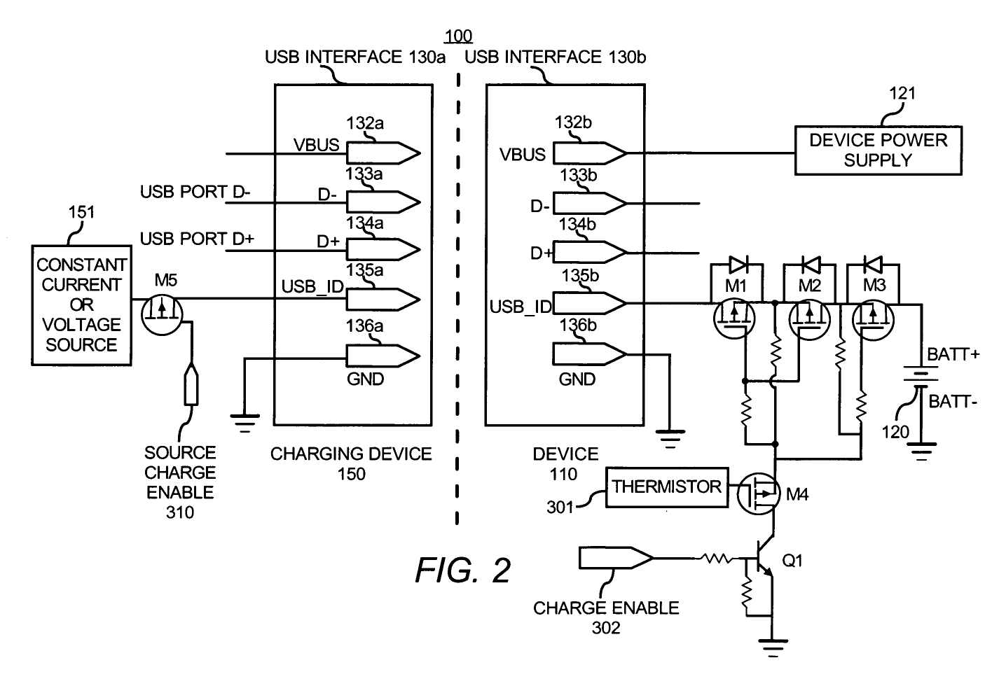

FIG. 2 illustrates an implementation of the charging control circuit 140 and battery monitor and control circuit 152 shown in FIG. 1, according to one embodiment. One of ordinary skill in the art would readily recognize that the circuits 140 and 152 may be implemented with other designs. The charging control circuit 140 and the switch S2 shown in FIG. 1 may include switches M1-M3 connected in series between the USB_ID pin 135b and the battery terminal for the battery 120, as shown in FIG. 2. The switches M1-M3 may include field effect transistors (FETs) that are closed to enable charging of the battery 120 from the charging circuit 151 via the USB_ID pin 135b if a thermistor 301 indicates the battery temperature is lower than a threshold and a charge enable signal 302 is received from firmware, for example, running on an application-specific integrated circuit (ASIC) or a microprocessor. The charge enable signal 302 may be generated if no fault condition is detected and the VBUS signal from the charging device 150 is detected, for example, on the VBUS pin 132b. A closed FET is a FET that is conducting between its source and drain and an open FET is not conducting. As is known in the art, a FET may be conducting if the appropriate voltage is applied at its gate.

The FETs M1-M5 are P-FETs and switch Q1 is an NPN bipolar junction transistor (BJT) in the embodiment shown in FIG. 1. If M1-M4 and Q1 in the device 110 are closed, charging of the battery 120 is enabled. For M1-M3 to be closed, both M4 and Q1 must be conducting. Q1 is closed if the charge enable signal 302 is received at its base, which may represent that no fault condition is detected and the VBUS signal from the charging device 150 is detected. The charge enable signal 302 may be generated by an ASIC or microprocessor not shown. M4 is closed if the battery temperature is below the threshold. For example, M4 is normally closed. If the battery temperature rises above the associated threshold, the thermistor 301 opens M4 and hence M1-M3 are opened. This terminates charging through the charging device 150.

M1 and M2 may be provided with body diodes in opposite directions to prevent battery leakage through the body diode of M2 and to prevent leakage of charge current to the battery 120 through body diode of M1. M3 is a backup for M2 in case M2 fails. M3 is optional but may be provided for safety issues. Resistors shown connected to the switches may be provided for biasing the gate of the switches, as is known in the art.

The battery monitor and control circuit 152 and the switch S1 shown in FIG. 1 for the charging device 150 may include M5 and a source charge enable signal 310. M5 is closed if the source charge enable signal 310 is generated. The source charge enable signal 310 may be generated if the battery 120 is not fully charged and/or a fault condition is not detected. An ASIC or microprocessor not shown may be provided in the charging device 150 that is operable to monitor the battery voltage and detect fault conditions.

According to another embodiment, a system is provided for controlling boot up of a device from a secondary device using a USB_ID pin of a USB interface. A secondary device connected to the device is identified via the USB_ID pin, and a boot up sequence for the device is controlled based on the identified secondary device. For example, a device, such as a digital camera, is turned off. The device is connected to a secondary device, such as a dock on a printer, using a USB interface with a USB_ID pin. The secondary device is recognized by the device if a signal (referred to as an identification signal), such as a predetermined voltage or current, identifying the secondary device is detected on the USB_ID pin of the device. Then, a boot up sequence of the device is performed based on the type of secondary device connected to the device. For example, based on the type of secondary device connected, either battery power or power from the secondary device supplied on the VBUS line is used to boot up the device. Also, a determination is made as to whether the secondary device may provide input power for the device, such that the battery in the device does not need to supply power for the device and the battery may be charged by the secondary device.

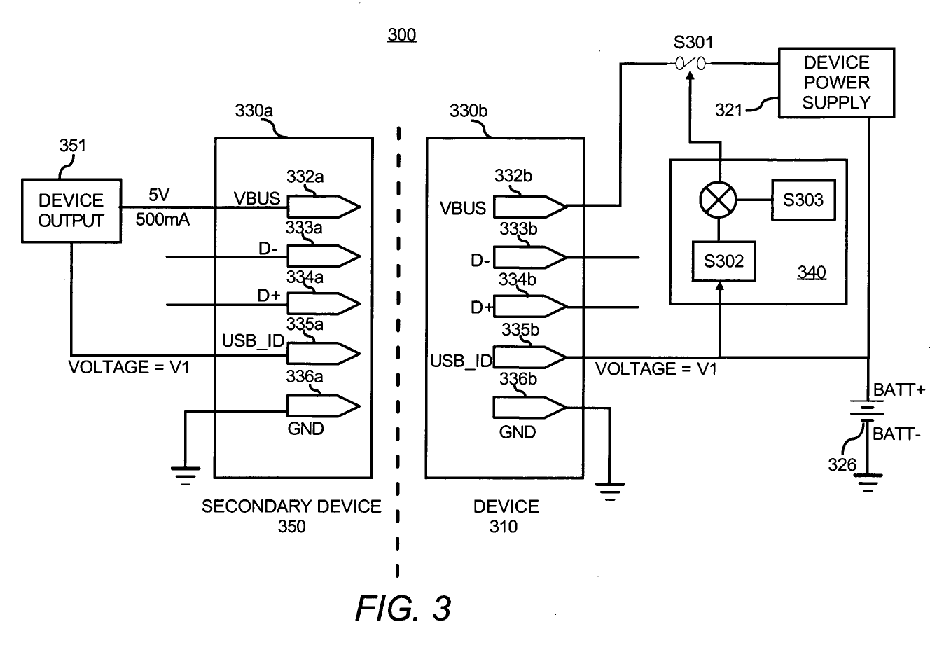

FIG. 3 illustrates a system 300 for controlling boot up of a device 310 from a secondary device 350. Similar to the device 110 and the recharging device 150 shown in FIGS. 1 and 2, the secondary device 350 includes a USB interface 330a, and the device 310 includes a USB interface 330b. For example, the USB interface 330a is a USB plug, and the USB interface 330b is a USB receptacle or vice versa.

Each of the USB interfaces 330a and 330b includes a set of pins 332a-336a and 332b-336b, including a VBUS pin 332a and 332b, two data pins (D− and D+) 333a, 333b, 334a and 334b, a USB_ID pin 335a and 335b and a ground pin (GND) 336a and 336b. The USB interfaces 330a and 330b including the pins 332a-336a and 332b-336b conform to the USB specification promulgated by the USB Implementers Forum. In particular, the USB On The Go (OTG) specification describes the USB_ID pin in addition to the other four pins, i.e., two for data, one for power (VBUS) and one for ground, shown in FIG. 3. The USB interfaces including the USB_ID pin are typically provided in Mini-B USB interfaces described in the current USB specification. The USB_ID pin may be any fifth pin in a USB compatible interface, other than the data pins, VBUS and GND pins.

The device 310, similar to the device 110 shown in FIGS. 1 and 2, may include any device with a USB interface including a USB_ID pin and a VBUS pin. For example, the device 310 may include a portable electronic device, such as a digital camera, cellular phone, PDA, media player, etc., or a non-portable electronic device with the USB interface. The secondary device 350 may include a device operable to supply current via the USB interface, and in particular the VBUS pin, to boot up the device 310. The secondary device 350 may include an accessory device, such as a printer, or a portable device that is conventionally not able to boot up the device 310 but is operable to boot up the device 310 when including the functionality described with respect to this embodiment. The secondary device 350 may include a PC, which is conventionally operable to boot up the device 310, however, according to this embodiment the PC may boot up the device 310 based on a signal provided via the USB_ID pin in the device 310. The secondary device 350 may include the charging device 150 shown in FIG. 1, such as a dock or other device operable to charge a battery in the device 310 if the device 310 includes a battery.

The device 310 includes a boot up control circuit 340 enabling or disabling boot up of the device 310 from the secondary device 350. The boot up control circuit 340 is operable to open or close a switch S301 to enable or disable boot up of the device 310 via the VBUS pin 332b.

The boot up control circuit 340 includes an input connected to the USB_ID pin 335b. The USB_ID pin 335b is used to recognize the secondary device 350 attached to the device 310 via the USB interfaces 330a and 330b, and then control the self boot up sequence of the device 310 based on the secondary device identification. For example, the secondary device 350 sends an identification signal to the device 310 via the USB_ID pin 335b. For example, the identification signal is an analog voltage V1 and if V1 at the USB_ID pin 335b is greater than a threshold voltage Vth, the boot up control circuit 340 identifies the secondary device 350 as a device that is operable to boot up the device 310.

The boot up control circuit 140 may include a switch S302 and a switch S303. If either S302 or S303 is closed, the switch S301 is closed connecting input power from the secondary device 350 to the device power supply 321 to execute boot up. In the example described above, if V1 at the USB_ID pin 335b is greater than a threshold voltage Vth, S302 is closed causing S301 to close. Then, the device 310 is booted up using power supplied via the VBUS line. S302 may be a hardware controlled switch as described in further detail with respect to FIG. 3.

If V1 is less than Vth, then the boot up control circuit 340 opens the switch S2, so the power supply 321 does not receive current via the VBUS pin 332b and cannot be booted up from current provided by the VBUS pin. In this example, V1 is representative of the identification signal of the secondary device 350. If the device 310 recognizes the secondary device 350 from the identification signal, i.e., V1>Vth, this enables VBUS power supplied to the device 310 for booting up the device 310.

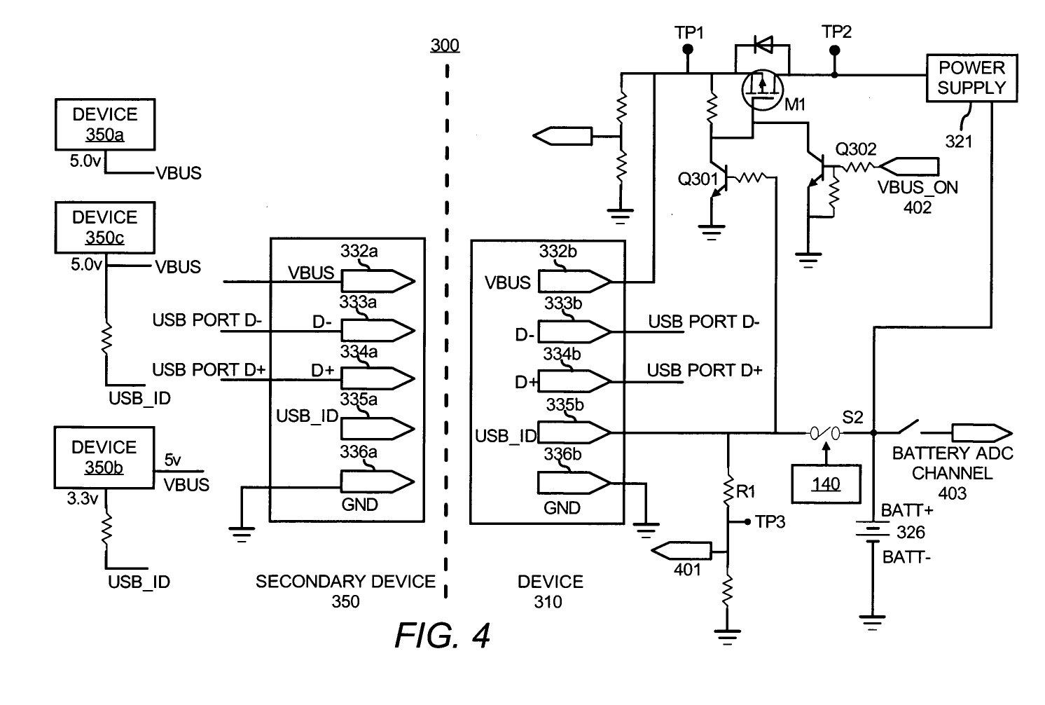

The Vth voltage can be set at different levels which can be used to enable boot up only from selected secondary devices. An example of using multiple threshold voltages to identify different secondary devices to control boot up of the device 310 is described with respect to FIG. 4.

The boot up control circuit 340 may also close the switch S303 to allow the secondary device 350 to supply power via the VBUS pin 332b even if the boot up control circuit 340 does not allow the secondary device 350 to boot up the device 310. For example, the boot up control circuit 340 identifies the secondary device 350 from its identification signal as a device that is not operable to boot up the device 310 because it does not typically provide sufficient power on the VBUS line to boot up the device 310. The device 310 may use power from the battery 326 to boot up. Then, a microprocessor, not shown, in the device 310 may request the secondary device 350 to increase voltage and/or current on the VBUS line. If the secondary device 350 provides adequate power on the VBUS line, the boot up control circuit 340 closes S303. This causes S301 to close and the secondary device 350 supplies power for the device 310. Then, the battery 326 may be recharged if the secondary device 350 is operable to recharge the battery 326, for example, via the USB_ID line, such as described with respect to FIGS. 1 and 2.

The secondary device 350 includes a device output circuit 351. The device output circuit 351 is operable to generate the identification signal on the USB_ID pins 335a and 335b, which in the example described above is V1. The device output circuit 351 is also operable to generate the power signal supplied via the VBUS pins 332a and 332b to the power supply 321, which may be used to boot up the device 310. In one example, the power signal is a 500 mA and 5V.

The boot up control circuit 340 may be used with the charging control circuit 140. For example, the switch S2 controlled by the charging control circuit, shown in FIG. 1, may be added between the USB_ID pin 335b and the battery 326 in the device 310 shown in FIG. 3 for controlling charging of the battery 326. This is described in further detail with respect to FIGS. 1, 4 and 5.

FIG. 4 illustrates one implementation of the boot up control circuit 340 and switches shown in FIG. 3, according to an embodiment. One of ordinary skill in the art would readily recognize that other designs may be used. The boot up control circuit 340 and the switch S301 includes switches M1, Q301 and Q302. These switches may be FETs. For example, M1 is the switch S301 shown in FIG. 3 and is a P-FET in this implementation. Q301 and Q302 are NPN BJT and are the switches S302 and S303 respectively. If either S302 or S303 are closed, S301 is closed and the secondary device 350 is operable to supply power to the device 310 via VBUS pin 332b.

As described above, Q301 is closed if the identification signal provided by the secondary device 350 identifies a device previously approved for booting up the device 310. FIG. 3 provides three examples of secondary devices, shown as 350a-c. In one example, the device 310 uses two voltages, Vth1 and Vth2, to identify two different secondary devices that are operable to booted up the device 310. For example, Vth1=3.3V+−5% and Vth2=5V+−10%. If the identification signal provided by one of the secondary devices 350a-c is equal to 3.3V with a tolerance of +−5% or is equal to 5V with a tolerance of +−10%, Q301 is closed and the device 310 may be booted up using input power on VBUS. If the identification signal is less than 1V, then the device 310 cannot be booted up by the secondary device.

For example, the secondary device 350b generates a 3.3V signal on the USB_ID pin 335b if connected to the device 310 via the USB interface 330b. This causes Q301 to close, which in turn closes M1. Hence, VBUS power is supplied to device 310, and the device 310 is booted up. The secondary device 350c, for example, generates a 5V signal on the USB_ID pin 335b if connected to the device 310 via the USB interface 330b. This also causes Q301 to close, which in turn closes M1. The secondary device 350a, for example, generates no signal on the USB_ID pin 335b and as a result 0V are detected on the USB_ID pin 335b if the secondary device 350a is connected to the device 310 via the USB interface 330b. In this case Q301 is open, and M1 is open. Thus, the device 310 is not booted up using input power on VBUS because the secondary device 350a is not recognized by the device 310 as a device operable to boot up the device 310.

Terminal 401 may be used to determine the voltage on the USB_ID line, i.e., the identification signal, to identify the secondary device 350. The terminal 401 may be connected to an A to D converter converting the voltage to a digital signal, which may be used by a microprocessor, not shown, to identify the secondary device.

Terminal 404 may be used to detect the voltage or current on VBUS. This may be used as input for the charging control circuit 140 or the boot up control circuit 340 as shown in FIG. 3

Q302 may be used to provide firmware control of the power supplied via the VBUS pin 332b to the power supply 321 and to control the boot up sequence, as described above. For example, the secondary device 350a is connected to the device 310 and generates no signal on the USB_ID pin. The boot up control circuit 340 identifies the secondary device 350a as a PC, and boots up using power from the battery 326. Then, a microprocessor, not shown, in the device 310 may request the secondary device 350a to increase voltage and/or current on the VBUS line. If the secondary device 350 provides adequate power on the VBUS line, VBUS_ON 402 is turned ON and Q302 is closed. As a result, M1 is closed, and the secondary device 350a supplies power for the device 310. Then, the battery 326 may be disconnected from the power supply 321 and charged via the USB_ID line if the secondary device 350a is operable to charge the battery 326, such as described with respect to FIGS. 1 and 2. For example, the charging control circuit 140 is operable to close S2 if the secondary device is operable to charge the battery 326.

The battery analog-to-digital converter (ADC) channel 403 monitors the battery voltage. For example, a switch connected to 403 may periodically close so the battery voltage is input to an ADC. A microprocessor may determine whether the battery is in a fault condition, for example, if the battery voltage is below 1V or greater than 3.8V, based on the battery voltage. If a fault condition is detected, then S2 is opened, as described with respect to FIG. 1. Other conditions described above may cause S2 to open or close.

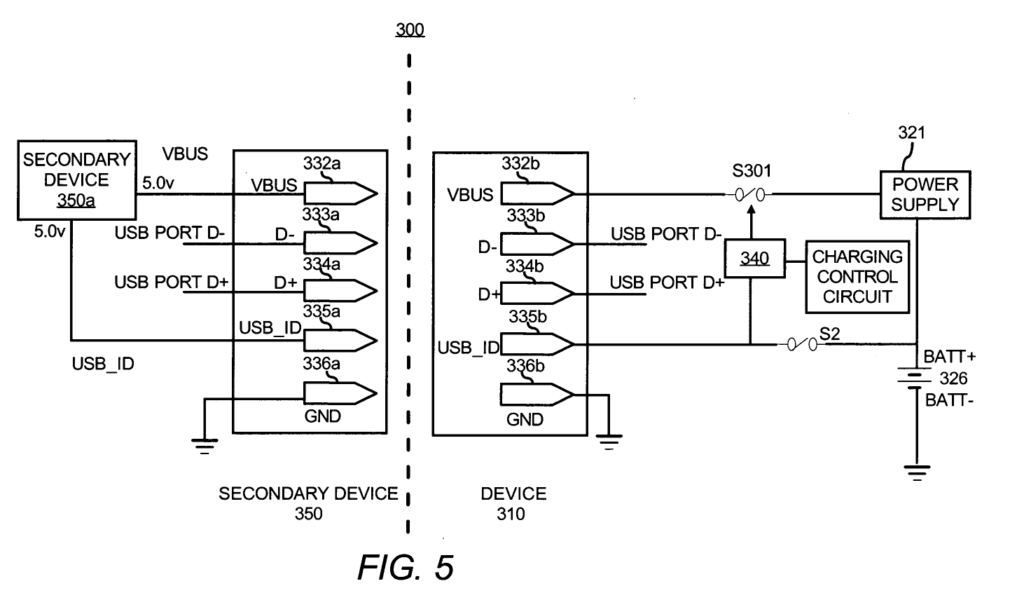

It should be noted that FIG. 4 illustrates an embodiment where the circuits of FIGS. 1 and 3 are provided together in a device. FIG. 5 also shows an embodiment including both the charging control circuit 140 in FIG. 1 and the boot up control circuit 340 shown in FIG. 3 in one device. The boot up control circuit 340 controls the switch S301 to control boot up from the secondary device 350 and the boot up sequence of the device 310, such as described with respect to FIGS. 3 and 4. The charging control circuit 140 controls the switch S2 to control charging of the battery 326 via the USB_ID pin 335b, such as described with respect to FIGS. 1 and 2.

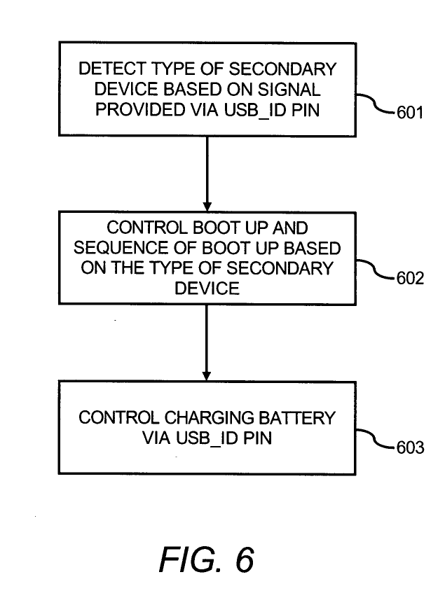

FIG. 6 illustrates a flow chart of a method 600 for controlling boot up of a device and controlling charging of a battery in the device, according to an embodiment. The method 600 is described with respect to one or more of FIGS. 1-5 by way of example. The method 600 may be implemented in other systems.

At step 601, a device detects a type of secondary device connected to the device based on a signal provided via a USB_ID pin in a USB interface. For example, the boot-up control circuit 340 shown in FIGS. 3 and 5 detects the type of secondary device connected to the device 310 based on the identification signal, such as an analog voltage, provided on the USB_ID pin.

At step 602, the boot up of the device and the sequence of the boot up is controlled based on the type of secondary device determined at step 601. For example, the boot-up control circuit 340 controls the initial boot up of the device 310 based on the type of the secondary device 350. If the boot up control circuit 340 identifies the secondary device 350 as being operable to boot up the device 310, the device 310 is booted up via the VBUS line. This initial boot up may include turning on the device 310 from power supplied via the VBUS pin. Also, the sequence of the boot up may be controlled based on the type of the secondary device. The sequence of the boot up includes the actions performed when turning on the device and actions subsequently performed after turning on the device. For example, the device 310 may be initially booted up using the battery 326 and then power may be subsequently supplied via the VBUS line from the secondary device 350. Also, the device 310 is operable to control messages displayed on a user interface for the device 310 based on the type of the secondary device 350. For example, a printer may be associated with one message and a standalone dock may be associated with another message.

At step 603, a battery in the device is charged from a charge supplied via the USB_ID pin if the device determines conditions are satisfied for charging the battery. For example, as described with respect to FIGS. 1, 2 and 5, the charging control circuit 140 determines whether the battery temperature is below a threshold, a VBUS signal is provided and no fault conditions are detected. If these conditions are satisfied, then the battery may be charged via the USB_ID pin.

One or more of the steps of the method 600 may be performed in different orders or one or more of the steps may be omitted. For example, a device may be operable to perform steps 601 and 602 and not step 603, or a device may be operable to perform step 603 and not steps 601 and 602.

One or more of the steps of the method 600 and other steps described herein may be implemented as software embedded or stored on a computer readable medium, such as a memory, and executed by a processor. The steps may be embodied by a computer program, which may exist in a variety of forms both active and inactive. For example, there may exist as software program(s) comprised of program instructions in source code, object code, executable code or other formats for performing some of the steps when executed, for example, by the processor. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. It is therefore to be understood that those functions enumerated herein may be performed by any electronic device capable of executing the above-described functions.

What is claimed is:

1. A device comprising:
a rechargeable battery;
a USB interface including a USB_ID pin; and
a battery charging circuit receiving a charge via the USB_ID pin from a charging device connected to the device via the USB interface, and the battery charging circuit charging the battery with the received charge.

2. The device of claim 1, wherein the battery charging circuit comprises:
a temperature control input enabling charging of the battery if a temperature of the battery is below a threshold.

3. The device of claim 2, wherein the battery charging circuit comprises:
a charge enable control input enabling charging of the battery if a predetermined voltage is provided from the charging device on a VBUS pin in the USB interface.

4. The device of claim 2, wherein the battery charging circuit comprises:
a charge enable control input enabling charging of the battery if no fault conditions of the battery are detected.

5. The device of claim 1, wherein the battery charging circuit comprises:
at least one switch connecting the USB_ID pin to the rechargeable battery if the at least one switch is closed.

6. The device of claim 5, wherein the at least one switch comprises:
a plurality of switches connected in series to the rechargeable battery, wherein the plurality of switches are closed only if a temperature of the rechargeable battery is below a threshold, if a predetermined voltage on a VBUS line of a USB cable connected to the USB interface is detected, and if no fault conditions of the battery are detected.

7. The device of claim 6, wherein the plurality of switches comprise two field effect transistors (FETs) in series and including body diodes in opposite directions to prevent leakage current.

8. The device of claim 7, wherein the two FETs are connected to a thermistor, and if the thermistor detects the temperature of the rechargeable battery being greater than the threshold, the two FETs are opened.

9. The device of claim 7, wherein the two FETs are connected to a firmware controlled input, and if the firmware does not detect the predetermined voltage on the VBUS line or detects a fault condition of the battery, the two FETs are opened.

10. The device of claim 7, further comprising:
a third FET in series with the two FETs and connected to the thermistor and the firmware controlled input, wherein the third FET operates as a backup FET if one of the two FETs fails.

11. The device of claim 1, wherein the charging device monitors a voltage of the battery via the USB_ID pin, and terminates supplying a charge to the battery via the USB_ID pin if the battery is fully charged or if a fault condition of the battery is detected.

12. The device of claim 1, wherein the device comprises a digital camera and the rechargeable device comprises a dock for the digital camera.

13. The device of claim 1, wherein the USB interface comprises:
the USB_ID pin, a VBUS pin, two data pins, and a ground pin.

14. The device of claim 1, further comprising:
a boot up control circuit identifying a type of secondary device connected to the device using an identification signal provided via the USB_ID pin in the USB interface and controls boot up of the device or a boot up sequence in the device based on the identified device type.

15. A device comprising:
a USB interface including a USB_ID pin and a VBUS pin, wherein a secondary device is connected to the device via the USB interface; and
a boot up control circuit controlling boot up of the device based on a voltage generated by the secondary device on the USB_ID pin and a type of the secondary device determined from the voltage.

16. The device of claim 15, further comprising:
a power supply; and
a battery, wherein the power supply is operable to receive power from the battery or the secondary device via the VBUS pin, and the boot up control circuit enables boot up of the device from power supplied from the battery or the VBUS pin based on the type of the secondary device.

17. The device of claim 16, wherein the boot up control circuit enables boot up of the device using power supplied via the VBUS pin if the device identifies the secondary device as a type of device operable to boot up the device and a predetermined current or voltage is detected on the VBUS pin.

18. The device of claim 16, wherein the boot up control circuit controls a boot up sequence of the device based on the type of the secondary device.

19. The device of claim 18, wherein the boot up control circuit enables boot up of the device using power supplied via the battery if the device identifies the secondary device as a type of device not operable to boot up the device.

20. The device of claim 18, wherein the boot up control circuit switches power provided from the battery to power provided from the secondary device via the VBUS pin if the device subsequently determines the secondary device is operable to provide sufficient power via the VBUS pin for operating the device.

21. The device of claim 16, wherein the boot up control circuit comprises a first switch that is closed to connect to the VBUS pin to the power supply if a second switch or a third switch is closed, wherein the second switch is closed if the type of the secondary device is determined to be a type of device operable to boot up the device and the third switch is closed if the device determines after boot up that the secondary device is operable to provide sufficient power via the VBUS pin for operating the device.

22. The device of claim 15, wherein the device is operable to display a message on a user message based on the determined type of the secondary device.

23. The device of claim 15, further comprising:
a battery charging circuit receiving a charge via the USB_ID pin from a charging device connected to the device via the USB interface, and the battery charging circuit charging a battery in the device with the received charge.

24. A method for controlling power supplied to a device from a secondary device, the method comprising:
controlling boot up of the device from a secondary device connected to the device via a USB_ID pin and a VBUS pin in a USB interface; and
controlling charging of a rechargeable battery in the device using a constant current or voltage supplied by the secondary device via the USB_ID pin.

25. The method of claim 22, wherein controlling boot up of the device comprises:
booting up the device using a current supplied to a power supply in the device from the secondary device via the VBUS pin if a voltage provided on the USB_ID pin by the secondary device identifies the secondary device as a type device operable to boot up the device.

26. The method of claim 22, further comprising:
controlling a boot up sequence of the device based on the determined type of the secondary device.
